(19) United States
(12) Patent Application Publication
(10) Pub. No.: US 2002/0141549 A1
(43) Pub. Date: Oct. 3, 2002

(54) Method and apparatus to explain features of a telephone to a user

(75) Inventors: Alexander Houston Swanson, Perth (GB); Chris Paulson-Ellis, Edinburgh (GB); Scott Mervyn Walker, Edinburgh (GB)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: 3Com Corporation

(21) Appl. No.: 09/933,585

(22) Filed: Aug. 21, 2001

(30) Foreign Application Priority Data
Mar. 30, 2001 (GB) 0108054.8

(51) Int. Cl. H04M 11/00

(52) U.S. Cl. 379/88.16

(57) ABSTRACT

A method and apparatus to assist users to understand the operation of a telephone in a system comprising a telephone with buttons, a telephone controller and a memory, said method comprising

providing said memory with a plurality of messages, each message explaining the function of a respective button on the telephone,

causing said telephone to enter a help state,

pressing a target button when said telephone is in said help state, and receiving the message associated with the target button pressed.

### BACKGROUND TO THE INVENTION

The invention relates to a method and apparatus to explain features of a telephone to a user and in particular a method and apparatus to assist users to understand the operation of a telephone.

Modern telephones have many buttons which are associated with a feature of the phone. It is common for the buttons to have either a single word description or a symbol printed on the button or on the phone's surface beside the button. Manufacturers prefer symbols as they can be used in countries which use different languages. Other buttons have space for a small printed paper label to be fixed on or beside them.

However the space available for printed descriptions or the symbol itself does not allow for a meaningful description and many users do not understand the features of the phone which are available to them. Permanently printed buttons and pre-printed labels are difficult to translate into another language and paper labels are hard to use and time-consuming to create.

Modern telephones have “feature” buttons ranging from the simple “redial” button common to almost all phones to a business phone having feature buttons such as “forward” to forward calls to another number, “confer” which allows more than two parties to speak, “no calls” which bars incoming calls, “group”, “intrude”, “call back”which causes the telephone to call back a remote number when it is no linger engaged, “camp on” and “divert”. In some cases a business phone may have hundreds of available features and tens of programmable buttons.

Furthermore most telephones have memory buttons which typically provide single stroke dialling of commonly used numbers (sometimes referred to as “speed dialing”).

It would be desirable therefore to provide the user with an easy to use and simple explanation of the features of the phone and in particular the features associated with each button.

### SUMMARY OF THE INVENTION

According to a first aspect, the present invention provides a method to explain features of a telephone to a user in a system comprising a telephone with buttons and a memory, said method comprising

providing said memory with a plurality of messages, each message explaining the function of a respective button on the telephone,

causing said telephone to enter a help state,

pressing a target button when said telephone is in said help state, and receiving the message associated with the target button pressed.

Where said telephone includes a dedicated help button, said step of causing said telephone to enter a help state preferably comprises pressing said help button.

Alternatively, said step of causing said telephone to enter a help state comprises pressing said target button for an extended time.

Alternatively, said step of causing said telephone to enter a help state comprises pressing said target button more than once.

The received message may be an audio message or alternatively where the telephone includes a display, the received message may be displayed on the telephone's display.

According to a second aspect, the present invention provides a telephone system comprising a telephone with buttons, a processor and a memory, said memory including a plurality of messages, each message explaining the function of a respective button on the telephone, help means being provided to cause said telephone to enter a help state, whereby when a target button is pressed when said telephone is in said help state, said processor causes the message associated with the target button to be passed to the telephone.

Said memory and processor may be part of the telephone or where said telephone is part of a network, said memory and processor may be remote from said telephone.

Said help means may comprise a dedicated help button on the telephone and pressing said help button causes said telephone to enter the help state.

Said help means may comprise means for detecting that a target button has been pressed for an extended time.

Said help means may comprise means for detecting that a target button has been pressed more than once.

According to a third aspect, said invention comprises a method to explain features of a phone to a user in a system comprising a phone with buttons, a speaker and or a handset and a memory, the system including a call processor, said method comprising the following steps:

First Step: Phone is on the hook. Call processor is in idle state, waiting for a phone to go off hook.

Second Step: Phone goes off hook and call processor goes into dial state waiting for button presses from phone.

Third Step: Call processor waiting for button press signals.

Fourth Step: Call processor gets button press signal when user presses a button. If signals are not from help button, go to fourth step. If signals are from help button go to fifth step.

Fifth Step: Digits are collected as usual and call processor carries out the usual operation in response to that signal.

Sixth Step: Call processor goes into help state and waits for button press signals from the user to indicate which button the help is required for.

Seventh Step: Get button signal when user presses a button.

Eighth Step: Call processor looks up a table in memory to find which audio message describes the actions of the pressed button on that specific phone.

Ninth Step: Audio message is passed to speaker or handset and played to user. Return to third step.

### BRIEF DESCRIPTION OF THE DRAWINGS

Preferred embodiments of the invention will now be described by way of example only and with reference to the accompanying drawings in which;

FIG. 1 is a view of a POTS telephone in accordance with a first embodiment of the invention,

FIG. 2 is a view of a telephone and PBX system in accordance with a second embodiment of the invention,

FIG. 3 is a view of a telephone and network system in accordance with a third embodiment of the invention,

FIG. 4 is a view of a mobile telephone (cellular phone or cellphone) in accordance with a fourth embodiment of the invention, and

FIG. 5 is a flowchart illustrating the operation of the preferred embodiments of the invention.

### DESCRIPTION OF THE PREFERRED EMBODIMENTS

The invention is based on the realisation that one can use the telephone to provide the explanation of the use of a feature or other button via the handset speaker as spoken explanation or via the handset screen where it is provided with one.

According to a preferred aspect, the phone includes means to access a new feature to be referred to as “online help”. The online help provides a spoken description of any of the phone's features through the phone's handset or speaker system By using a spoken description, all of the problems identified above may be overcome.

Thus there is no limitation on the number of words that can be used to describe a feature. There is no need to permanently print a description on the phone and there is no need to create and fix paper descriptions to the phone. Also, full spoken description are much more easy to translate than single word descriptions.

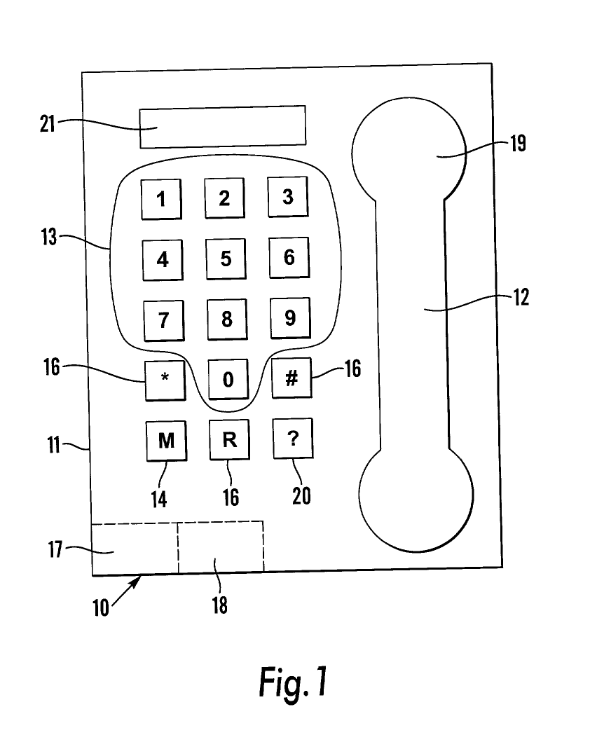

The “online help” feature can be activated in a variety of ways. In a preferred arrangement shown in FIGS. 1 to 4, there is provided on the relevant telephone a dedicated button 20 carrying the internationally recognised “?” symbol.

FIG. 1 shows a conventional telephone 10 (POTS plain old telephone service). The telephone comprises a base unit 11 and a handset 12. The base unit includes the normal number/letter buttons 13, memory buttons 14 and function buttons 16 as well as a help (?) button 20.

The base unit includes a processor 17 and a memory 18. The memory 18 includes data to provide audio messages through a speaker 19 of the handset or written information on a display 21 of the base unit. The memory, which is preferably a solid-state memory, includes a plurality of audio messages, each explaining the function of a respective memory button 14 or function button 16. The processor 17 controls the memory 18 on the basis of the buttons depressed by the user.

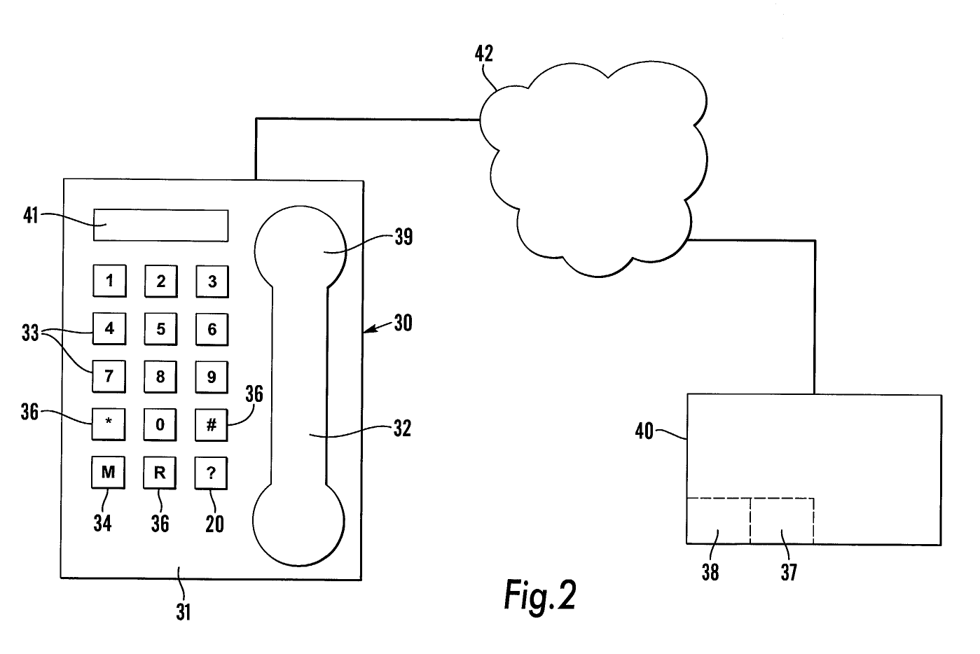

FIG. 2 illustrates a PBX telephone system including a telephone 30 connected to a remote controller 40 to which similar phones are connected. The network is illustrated by cloud 42 in a conventional way. The telephone 30 is similar to the telephone of FIG. 1 except that it does not include the processor or memory, the relevant memory 38 and processor 37 being provided in the remote controller. Thus the telephone 30 comprises a base unit 31 and a handset 32. The base unit includes the normal number/letter buttons 33, memory buttons 34 and function buttons 36 as well as a help (?) button 20.

The memory 38 includes data to provide audio messages through a speaker 39 of the handset or written information on a display 41 of the base unit. The memory, which is preferably a solid-state memory, includes a plurality of audio messages, each explaining the function of a respective memory button 24 or function button 26. The processor 37 controls the memory 38 on the basis of the buttons depressed by the user.

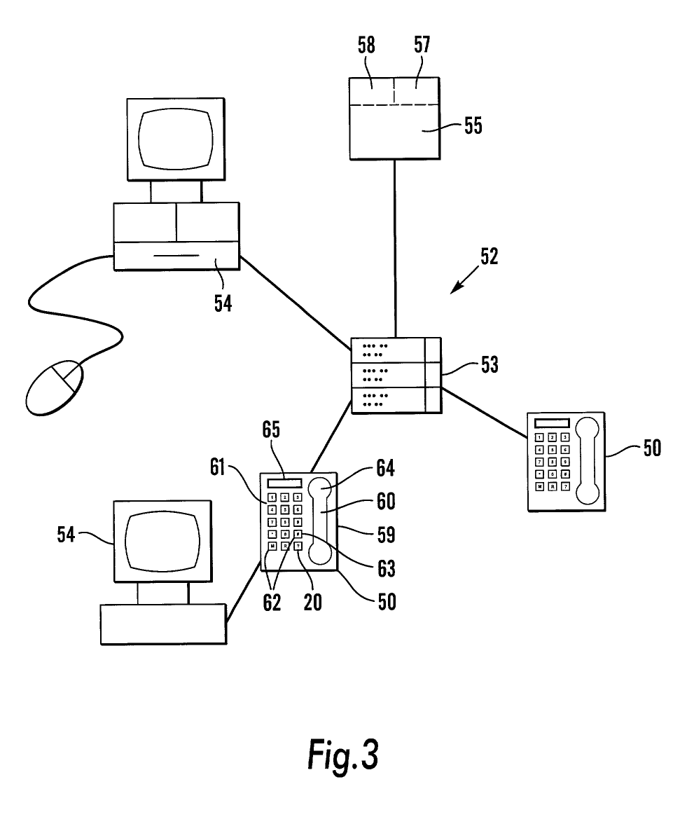

FIG. 3 illustrates a telephone system incorporated in a local area computer network. A telephone 50 is connected in a network 51 comprising devices 52 including switches, hubs 53 and workstations 54. The telephone is connected through the network with a telephone controller 55 to which similar phones are connected. The telephone 30 is similar to the telephone of FIG. 1 except that it does not include the processor or memory, the relevant memory 58 and processor 57 being provided in the remote telephone controller 55. Thus the telephone 30 comprises a base unit 59 and a handset 60. The base unit includes the normal number/letter buttons 61 memory buttons 62 and function buttons 63 as well as a help (?) button 20.

The memory 58 includes data to provide audio messages through a speaker 64 of the handset or written information on a display 65 of the base unit. The memory, which is preferably a solid-state memory, includes a plurality of audio messages, each explaining the function of a respective memory button 62 or function button 63. The processor 57 controls the memory 58 on the basis of the buttons depressed by the user.

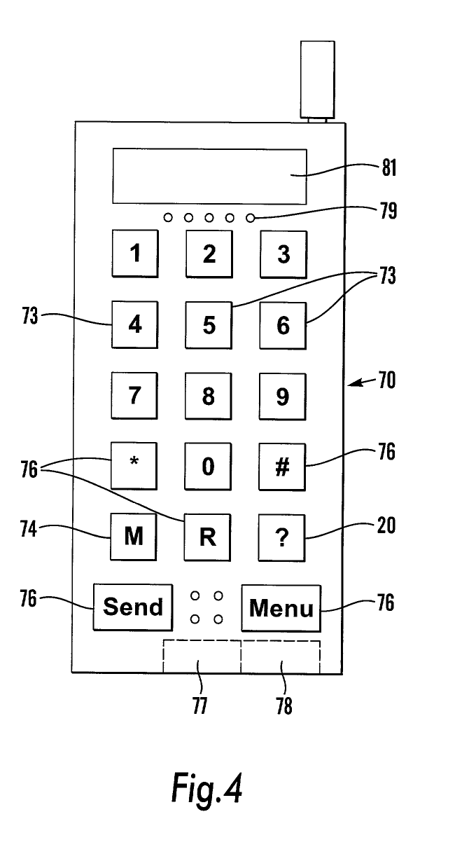

FIG. 4 illustrates a cellular phone handset 70. The phone 70 includes the normal number/letter buttons 73, memory buttons 74 and function buttons 76 as well as a help (?) button 20. It includes a processor 77 and a memory 78. The memory 78 includes data to provide audio messages through a speaker 79 of the handset or written information on a display 81 of the base unit. The memory, which is preferably a solid-state memory, includes a plurality of audio messages, each explaining the function of a respective memory button 74 or function button 76. The processor 77 controls the memory 78 on the basis of the buttons depressed by the user.

Thus, for a user of any of the systems of FIGS. 1 to 4 to obtain an explanation of the use of a particular button, the user presses the “?” button 20 followed by the button he/she is curious about. At that point a spoken description of the feature associated with the second button would come from the speaker of the phone handset.

In detail, pressing the help button 20 passes a coded signal to the processor in each case. This puts the telephone into a “help” state. Pressing another (“target”) button causes the processor to load from the memory the audio message relevant to that target button -and to pass that message to the speaker of the relevant phone.

In a more sophisticated system, the message may include questions for the user to answer so that the necessary information desired may be sent to the speaker.

The memory may include messages in more than one language if desired and the buttons and microphone may be used by a user to install messages on the memory (for example, the names of persons associated with memory telephone numbers)

The memory required to store spoken online help in the phone depends on the way in which the audio information is stored. The lowest quality format which one might reasonably use and still have the audio sound like a normal telephone, is a format called ADPCM. In this format audio can be stored in approximately 4Kbytes per second. Thus a 5 second message for 20 different buttons on a phone would require about 400Kbytes of storage.

Instead of providing a dedicated help button 20, the feature could be activated by dialing a certain code and then pressing the button requiring help and thereby causing the telephone to enter its “help” state. This requires that the relevant code is remembered. Alternately, the help feature can be activated by pressing the target button for an extended time (e.g. 1 or 2 or 3 seconds) or “double clicking” the target button. This is not be as usable a method as the others described since it is difficult for users to differentiate between asking for help on a button and activating the primary function of the button. In this case the call processor includes means to detect whether the target button has been pressed for an extended time of 1, 2 or 3 seconds (or any other chosen time) or has been pressed more than once.

As mentioned above, the online help could be associated with selections on a handset's display. Many phones have displays which provide another interface to the telephone systems features. This can range from a single line LCD to a larger screen similar to a PC. On such systems, thehelp feature can be provided through whatever interface is employed on the visual display. Thus the memory may store the messages as text messages for display.

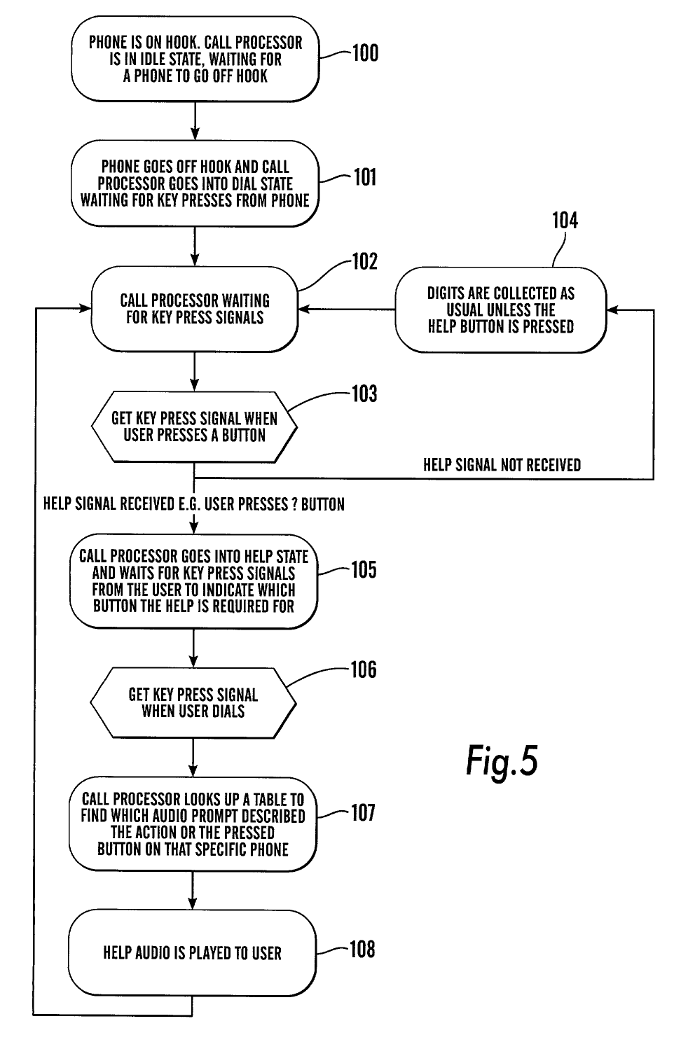

FIG. 5 is a flow diagram of the method of the invention.

Step 100: Phone is on the hook. Call processor is in idle state, waiting for a phone to go off hook.

Step 101: Phone goes off hook and call processor goes into dial state waiting for button presses from phone.

Step 102: Call processor waiting for button press signals.

Step 103: Call processor gets button press signal when user presses a button. If signals are not from help button, go to step 104. If signals are from help button go to step 105.

Step 104: Digits are collected as usual and call processor carries out the usual operation in response to that signal.

Step 105: Call processor goes into help state and waits for button press signals from the user to indicate which button the help is required for.

Step 106: Get button signal when user presses a button.

Step 107: Call processor looks up a table to find which audio message describes the actions of the pressed button on that specific phone.

Step 108: Audio message is passed to speaker or handset and played to user. Return to step 102.

Whilst we have used the word “button” throughout, it will be understood that the word covers buttons, keys and other manually operated devices to input the relevant number or function to the telephone.

The invention is not restricted to the details of the foregoing examples.

1. A method to explain features of a telephone to a user in a system comprising a telephone with buttons and a memory, said method comprising the steps of:
providing said memory with a plurality of messages, each message explaining the function of a respective button on the telephone,
causing said telephone to enter a help state,
pressing a target button when said telephone is in said help state, and receiving the message associated with the target button pressed.

2. A method as claimed in claim 1 in which said telephone includes a dedicated help button and said step of causing said telephone to enter a help state comprises pressing said help button.

3. A method as claimed in claim 1 in which said step of causing said telephone to enter a help state comprises pressing said target button for an extended time.

4. A method as claimed in claim 1 in which said step of causing said telephone to enter a help state comprises pressing said target button more than once.

5. A method as claimed in claim 1 in which the received message is an audio message.

6. A method as claimed in claim 1 in which the telephone includes a display and the received message is received on the telephone's display.

7. A telephone system comprising a telephone with buttons, a processor and a memory, said memory including a plurality of messages, each message explaining the function of a respective button on the telephone, help means being provided to cause said telephone to enter a help state, whereby when a target button is pressed when said telephone is in said help state, said processor causes the message associated with the target button to be passed to the telephone.

8. A telephone system as claimed in claim 7 in which said memory and processor are part of the telephone.

9. A telephone system as claimed in claim 7 in which said telephone is part of a network in which said memory and processor are remote from said telephone.

10. A telephone system as claimed in claim 7 in which said help means comprises a dedicated help button on the telephone and pressing said help button causes said telephone to enter the help state.

11. A telephone system as claimed in claim 7 in which said help means comprises means for detecting that a target button has been pressed for an extended time.

12. A telephone system as claimed in claim 7 in which said help means comprises means for detecting that a target button has been pressed more than once.

13. A telephone system as claimed in claim 7 in which the messages comprise audio messages.

14. A telephone system as claimed in claim 7 in which the telephone includes a display and the messages comprise text messages to be displayed on the telephone's display.

15. A method to explain features of a phone to a user in a system comprising a phone with buttons, a speaker and or a handset and a memory, the system including a call processor, said method comprising the following steps:
first step: Phone is on the hook. Call processor is in idle state, waiting for a phone to go off hook.
Second step: Phone goes off hook and call processor goes into dial state waiting for button presses from phone.
Third step: Call processor waiting for button press signals.
Fourth step: Call processor gets button press signal when user presses a button. If signals are not from help button, go to fifth step. If signals are from help button go to sixth step.
Fifth step: Digits are collected as usual and call processor carries out the usual operation in response to that signal.
Sixth step: Call processor goes into help state and waits for button press signals from the user to indicate which button the help is required for.
Seventh step: Get button signal when user presses a button.
Eighth step: Call processor looks up a table in memory to find which audio message describes the actions of the pressed button on that specific phone.
Ninth step: Audio message is passed to speaker or handset and played to user. Return to third step.
